(19) United States
(12) Patent Application Publication
(10) Pub. No.: US 2025/0074237 A1
(43) Pub. Date: Mar. 6, 2025

(54) FUEL CELLS FOR EV CHARGING

(71) Applicant: HYAXIOM, INC., East Hartford, CT (US)

(72) Inventors: Brian Chakulski, West Hartford, CT (US); Sridhar Kanuri, South Glastonbury, CT (US)

(21) Appl. No.: 18/242,101

(22) Filed: Sep. 5, 2023

(51) Int. Cl. B60L 53/54; B60L 53/10; B60L 53/302

(52) U.S. Cl. CPC B60L 53/54; B60L 53/11; B60L 53/302; B60L 53/18

(57) ABSTRACT

An illustrative example embodiment of a method and system is provided that uses a fuel cell to produce electricity to charge an electrified vehicle and to provide an additional output that is used to cool charging cables for the vehicle.

### BACKGROUND

With the increasing popularity of electric vehicles, charging station demand has also increased. Additionally, fast charge stations are becoming popular to provide more charge over a shorter period of time. Fast charging generates more waste heat in the cables. One approach to address this issue is the use large cables that can accommodate the heat generation; however these cables are bulky and difficult to move around. Another approach is to provide actively cooled charging cables; however this requires additional cooling components and additional energy to provide active cooling.

### SUMMARY

An illustrative example embodiment of a method includes: using a fuel cell to generate electricity for charging a vehicle.

In an embodiment having one or more features of the method of the previous paragraph, the method includes using heat from a fuel cell reaction of the fuel cell to drive a cooling process to cool charging cables for the vehicle.

In an embodiment having one or more features of the method of any of the previous paragraphs, the fuel cell comprises a phosphoric acid fuel cell (PAFC), and the method includes: generating waste heat from the PAFC; generating cooling energy from the waste heat via the cooling process; and cooling charging cables for the vehicle with the cooling energy.

In an embodiment having one or more features of the method of any of the previous paragraphs, the method includes: cooling water by-product of a fuel cell power plant with the cooling energy to provide cooled water; and cooling the charging cables with the cooled water.

In an embodiment having one or more features of the method of any of the previous paragraphs, the step of generating cooling energy from the waste heat includes using an absorption chiller.

In an embodiment having one or more features of the method of any of the previous paragraphs, the charging cables are for a fast charging station.

In an embodiment having one or more features of the method of any of the previous paragraphs, the fuel cell comprises a cell stack assembly in a fuel cell power plant.

An illustrative example embodiment of a system includes: a fuel cell; and an output connectable to an EV charger, wherein the fuel cell generates electricity that is communicated to the output.

In an embodiment having one or more features of the system of any of the previous paragraphs, the EV charger is connectable to a vehicle to charge the vehicle.

In an embodiment having one or more features of the system of any of the previous paragraphs, the system further includes charging cables that connect the EV charger to the vehicle, and wherein the fuel cell provides an additional output to cool the charging cables.

In an embodiment having one or more features of the system of any of the previous paragraphs, the fuel cell comprises a phosphoric acid fuel cell (PAFC), and wherein the PAFC generates waste heat that is used to generate cooling energy that is used to cool the charging cables.

In an embodiment having one or more features of the system of any of the previous paragraphs, water by-product of a fuel cell power plant is cooled with the cooling energy to provide cooled water, and wherein the cooled water cools the charging cables.

In an embodiment having one or more features of the system of any of the previous paragraphs, the system further includes an absorption chiller that generates the cooling energy from the waste heat.

In an embodiment having one or more features of the system of any of the previous paragraphs, the PAFC comprises a cell stack of PAFCs.

In an embodiment having one or more features of the system of any of the previous paragraphs, the charging cables are for a fast charging station.

In an embodiment having one or more features of the system of any of the previous paragraphs, the fuel cell comprises a cell stack assembly in a fuel cell power plant.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an example electric vehicle at a charging station.

FIG. 2 schematically illustrates an example fuel cell power plant.

FIG. 3 is a diagram illustrating a method using a fuel cell to charge the electric vehicle and/or cool a charging component.

FIG. 4 schematically illustrates an example fuel cell.

FIG. 5 schematically illustrates an example absorption chiller.

### DETAILED DESCRIPTION

Embodiments of this disclosure relate to a method and system that uses fuel

cells to produce electricity to charge a vehicle and to provide an additional output that is used to cool charging cables for the vehicle.

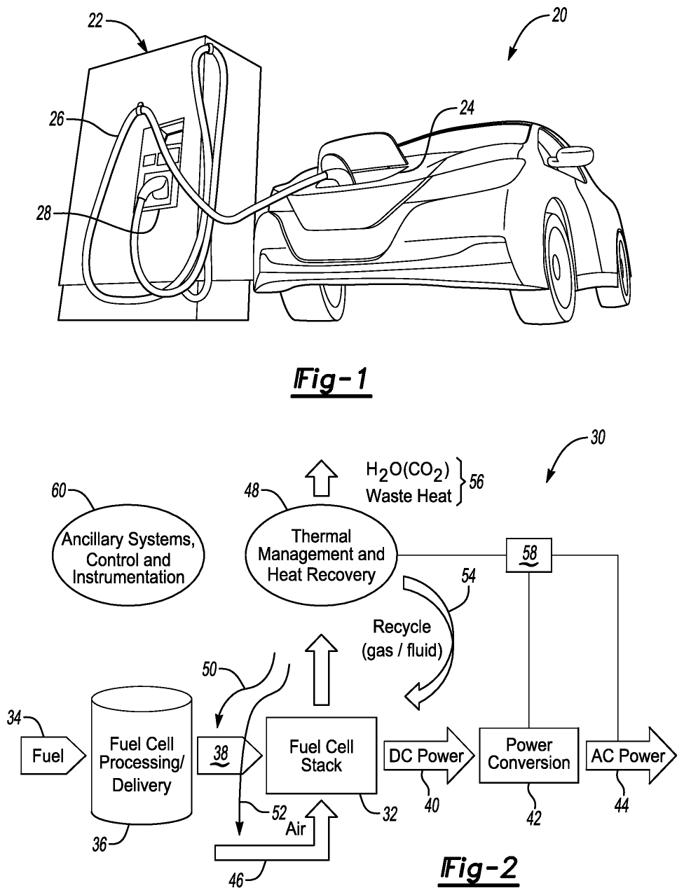

FIG. 1 schematically illustrates an example electric vehicle 20 that is being charged at a charging station 22. The electric vehicle 20 includes a charge port 24. At least one charging cable 26 connects a charging power source 28 at the charging station 22 to the charge port 24. The charging power source 28 is used to charge a high-voltage battery pack (not shown) that is located within the electric vehicle 20 in a known manner. Operation of the charging station 22 and charging of the electric vehicle 20 are accomplished using known techniques and existing structures.

As EV vehicles 20 become more popular, demand for charging stations 22 will increase. These charging stations 22 will need additional power sources to fulfill the demand. Current grid infrastructure may not be able to support this demand in a cost effective manner. Additionally, fast charging stations are required to provide more charge over a shorter period of time. Fast charging generates more waste heat in the cables due to IR losses. The subject disclosure uses fuel cell technology in a cost effective manner to provide a power source that is different from current power infrastructure used for charging services. The subject disclosure also uses fuel cell technology to provide a cooling source for charging stations.

FIG. 2 schematically illustrates selected portions of an example fuel cell power plant 30. A cell stack assembly (CSA) 32 includes a plurality of fuel cells that generate electrical power based on an electrochemical reaction. The fuel cells may take a variety of forms. For example, some fuel cells will be phosphoric acid fuel cells (PAFCs) while others will be polymer electrolyte membrane fuel cells (PEMs). Those skilled in the art who have the benefit of this description will be able to select an appropriate type of fuel cell and CSA arrangement to meet their particular needs.

In one example, fuel 34 is sent to a fuel cell processing and delivery system 36 that feeds into the CSA 32 as indicated at 38. The CSA 32 generates DC power 40 that is communicated to a power conversion system 42, e.g. inverters, where DC electrical power from the CSA 32 is converted into AC power 44 to be provided to a load external to the fuel cell power plant 30. Air 46 is supplied to the CSA 32 and a thermal management and heat recovery system 48 is used to thermally manage the fuel cell feed 38, the air supply 46, and the CSA 32 as respectively indicated by arrows 50, 52, 54. Output from the thermal management and heat recovery system 48 includes waste heat and H₂O(CO₂) as shown at 56.

A controller 58 controls operation of the power conversion system 42 to achieve a desired operation and output from the fuel cell power plant 30. The controller 58 also controls the thermal management and heat recovery system 48 and AC power output 44. The fuel cell power plant 30 also includes additional ancillary systems and instrumentation 60 as needed for operation of the fuel cell power plant 30. It should be understood that this is just one example of a fuel cell power plant 30 and other configurations could also be used.

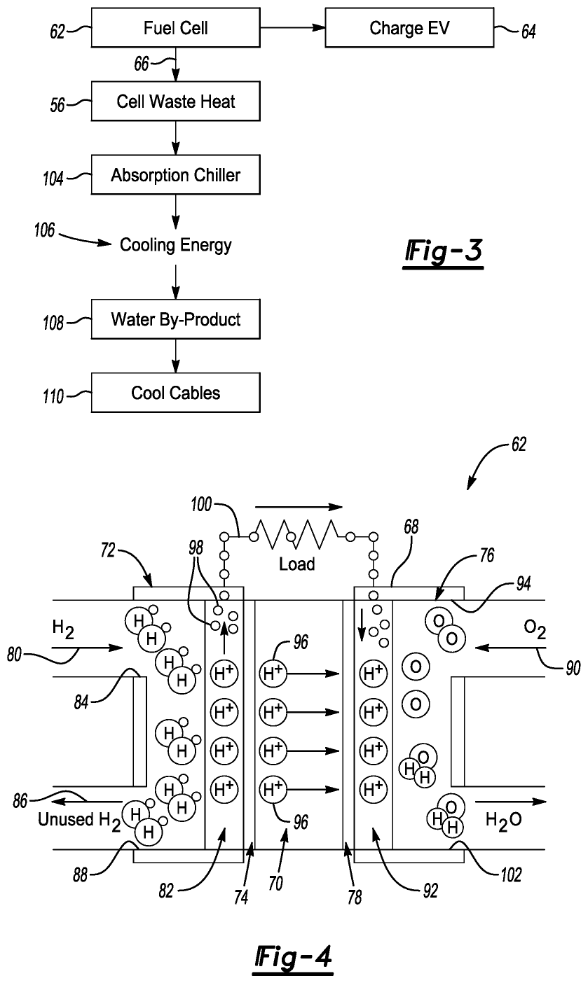

The subject disclosure uses one or more fuel cells 62 to produce electricity 64 to charge the electric vehicle 20 as shown in FIG. 3. The fuel cells 62 also provide an additional output 66 that is used to cool charging cables 26 for the electric vehicle 20.

FIG. 4 shows one example of a fuel cell 62. In this example, the fuel cell 62 comprises a PAFC 68. The PAFC 68 generates electrical energy based on an electrochemical reaction involving hydrogen and oxygen. PAFCs use liquid phosphoric acid as an electrolyte 70. An anode 72 and an anode catalyst layer 74 are on one side of the electrolyte 70 and a cathode 76 and a cathode catalyst layer 78 are located on an opposite side of the electrolyte 70. A supply 80 of H₂ is supplied to an anode gas diffusion layer 82 via an inlet 84 and unused H₂ 86 exits via an outlet 88. The cathode 76 is supplied with O₂ 90 from ambient air, which is directed to a cathode gas diffusion layer 92 via an inlet 94.

Positively charged hydrogen ions 96 migrate through the electrolyte 70 from the anode 72 to the cathode 76. Electrons 98 generated at the anode 72 travel through an external circuit 100, providing electric power, and return to the cathode 76. The H₂ combines with the O₂ at the cathode side and exits as H₂O via an outlet 102.

The electric power generated by the PAFC 68 comprises electricity that can be used for charging the electric vehicle 20. The PAFC 68 also has an additional output to provide a cooling function. As discussed above, the fuel cells 62 generate waste heat 56 (see FIGS. 2 and 3). In one example, an absorption chiller 104 uses the energy of the waste heat 56 to provide cooling energy 106. Absorption chillers 104 use a collection of waste heat from other processes or equipment to drive a thermodynamic process that allows water to be chilled and distributed for other heating and cooling needs.

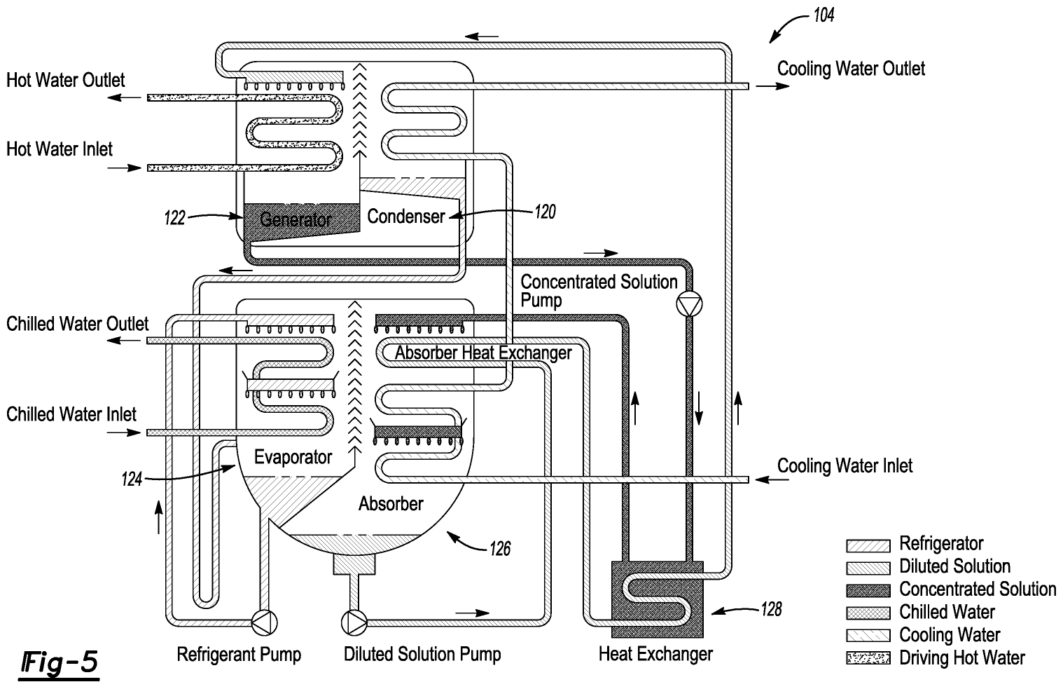

FIG. 5 shows one example of an absorption chiller 104. In this example, the absorption chiller 104 has a condenser 120, a generator 122, an evaporator 124, an absorber 126, and a heat exchanger 128. A refrigerant or another appropriate fluid, e.g. water mixed with lithium bromide, is stored in the absorber 126. This fluid is pumped through the heat exchanger 128 and goes to a tank of the generator 122. The waste heat generated from the fuel cell power plant 30 goes into the generator 122 and water is then separated under the heat. Water gradually becomes vapor and rises to the top, where the condenser 120 located, and the remaining separated part is directed back to the absorber 126. Then, the vapor in the condenser 120 on the top will go through a cooling tower. The cooling tower pipe has a lower air pressure than the condenser 120. Thus, the vapor becomes water again as the air pressure decreases. The cold water then goes into the evaporator 124 and waits to be mixed with the fluid from the absorber 126.

In short, the absorption chiller 104 chills water via sudden change of pressure. When the water heats up in the generator 122, the air pressure is high. Water releases the heat and becomes vapor. Then, a pipe leads the vapor to the evaporator 124, where the air pressure is low. The vapor will then cool down and become cold water again immediately. The outside temperature will drop as vapor absorbs the heat to become water. The water evaporates and carries away all the unwanted heat. Then, as it goes through the cooling tower, the vapor cools down in a low-pressure environment and becomes water again. Thus, an absorption chiller 104 produces chilled water while consuming just a small amount of electricity.

It should be understood that the absorption chiller 104 of FIG. 5 is just one example, and that any type of absorption chiller can be used to provide the cooling energy. Those skilled in the art who have the benefit of this description will be able to select an appropriate type of absorption chiller to meet their particular needs.

In one example, the waste heat of the fuel cells 62 is used to heat water. The resultant hot water is then fed to the absorption chiller 104 to generate chilled water, which can then be used to cool the EV cables 26 as indicated at 110. The hot water from the fuel cell power plant will be a colder temperature after interacting with the absorption chiller 104. This water can then be fed to the fuel cell power plant 30 and be re-heated in a continuous cycle.

Thus, the subject disclosure uses fuel cells to provide both a charging function and a cooling function. This is beneficial as a load that follows an electricity source while also providing a previously unused source of cooling, which would otherwise have to be satisfied by additional energy usage.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method comprising:
using a fuel cell to generate electricity for charging a vehicle.

2. The method according to claim 1, including using heat from a fuel cell reaction of the fuel cell to drive a cooling process to cool charging cables for the vehicle.

3. The method according to claim 2, wherein the fuel cell comprises a phosphoric acid fuel cell (PAFC), and including:
generating waste heat from the PAFC;
generating cooling energy from the waste heat via the cooling process; and
cooling charging cables for the vehicle with the cooling energy.

4. The method according to claim 3, including:
cooling water by-product of a fuel cell power plant with the cooling energy to provide cooled water; and
cooling the charging cables with the cooled water.

5. The method according to claim 3, wherein the step of generating cooling energy from the waste heat includes using an absorption chiller.

6. The method according to claim 2, wherein the charging cables are for a fast charging station.

7. The method according to claim 1, the fuel cell comprises a cell stack assembly in a fuel cell power plant.

8. A system comprising:
a fuel cell; and
an output connectable to an EV charger, wherein the fuel cell generates electricity that is communicated to the output.

9. The system according to claim 8, wherein the EV charger is connectable to a vehicle to charge the vehicle.

10. The system according to claim 9, including charging cables that connect the EV charger to the vehicle, and wherein the fuel cell provides an additional output to cool the charging cables.

11. The system according to claim 10, wherein the fuel cell comprises a phosphoric acid fuel cell (PAFC), and wherein the PAFC generates waste heat that is used to generate cooling energy that is used to cool the charging cables.

12. The system according to claim 11, wherein water by-product of a fuel cell power plant is cooled with the cooling energy to provide cooled water, and wherein the cooled water cools the charging cables.

13. The system according to claim 11, including an absorption chiller that generates the cooling energy from the waste heat.

14. The system according to claim 11, wherein the PAFC comprises a cell stack of PAFCs.

15. The system according to claim 10, wherein the charging cables are for a fast charging station.

16. The system according to claim 8, wherein the fuel cell comprises a cell stack assembly in a fuel cell power plant.
